(19) United States
(12) Patent Application Publication
(10) Pub. No.: US 2022/0116274 A1
(43) Pub. Date: Apr. 14, 2022

(54) ELECTRONIC DEVICE, SYSTEM, METHOD AND PROGRAM WITH ENHANCED DETECTION OF POTENTIAL BRICKING

(71) Applicant: ARRIS Enterprises LLC, Suwanee, GA (US)

(72) Inventors: Yongqiang YE, Shenzhen, Guangdong (CN); Shenxia TAN, Shenzhen, Guangdong (CN); Yongqin ZUO, Shenzhen, Guangdong (CN); Dongting ZHANG, Shenzhen, Guangdong (CN); Linzhou CAI, Shenzhen, Guangdong (CN)

(21) Appl. No.: 17/280,349

(22) PCT Filed: Apr. 28, 2020
(86) PCT No.: PCT/CN2020/087460

§ 371 Date: Mar. 26, 2021

(51) Int. Cl. H04L 41/0869; H04L 67/00

(52) U.S. Cl. CPC H04L 41/0869; H04L 67/34

(57) ABSTRACT

An electronic device features enhanced detection of potential bricking. A processor of the electronic device is configured to, after initiation of a download: (i) check data components defining download parameters of the electronic device; (ii) start a buffer and receive each of the data components; (iii) write each of the data components into flash memory; (iv) read each of the data components from the flash memory and perform a cyclic redundancy check (CRC) of each of the data components; (v) check a signature of each of the data components; (vi) update download settings in the non-volatile random access memory (NVRAM) based on results of (i), (iv) and (v); (vii) check client identifier information of the electronic device; (viii) check access identifier information of the electronic device; and (ix) accept the download if no error is detected and reject the download if any error is detected.

### TECHNICAL FIELD

The subject matter of the present disclosure relates generally to the implementation of operations for determining potential bricking issues with an electronic device such as a cable modem or gateway device.

### BACKGROUND

Wireless networks for providing services to client devices or end devices via a modem or gateway device are prevalent in many homes and businesses. Additionally, there can be several modems or gateway devices deployed in the home or business to enhance quality of service (QoS) in the network.

However, sometimes there can be problems with the operation of the modem or gateway device that interrupt services. For example, the modem and gateway device can stop working or exhibit glitches.

Software or firmware downloads may periodically be performed on the modem or gateway device so as to upgrade or downgrade programs running on the modem or gateway device.

However, with failed software or firmware downloads, errors during the download process can cause system-level damage after which the modem or gateway device fails to boot up or function whatsoever. This phenomenon is known as “bricking.” “Soft” bricking occurs when the modem or gateway device retains some functionality such as the ability to display the error whereas “hard” bricking occurs when the modem or gateway device retains virtually no functionality. For example, if any data in a manifest file is corrupted or non-volatile random access memory (NVRAM) is corrupted, then an incorrect download image with an incorrect manifest signature may be built and the modem or gateway device could fail to boot.

Existing solutions include basic authentication measures such as a cyclic redundancy check (CRC) to ensure a buffer received the same data as expected. However, the existing solutions simply provide limited ways to confirm some data integrity before writing to flash memory, cannot ensure that all manifest files are valid, and fail to detect or prevent potential causes of bricking.

Thus, it would be advantageous and an improvement over existing solutions to provide an electronic device, a method, and a program with enhanced detection of potential bricking of the electronic device.

### SUMMARY

An aspect of the present disclosure provides an electronic device with enhanced detection of potential bricking. The electronic device includes flash memory; NVRAM; and a processor. The processor is configured to, after initiation of a download: (i) check data components defining download parameters of the electronic device; (ii) start a buffer and receive each of the data components; (iii) write each of the data components into the flash memory; (iv) read each of the data components from the flash memory and perform a cyclic redundancy check (CRC) of each of the data components; (v) check a signature of each of the data components; (vi) update download settings in the NVRAM based on results of (i), (iv) and (v); (vii) check client identifier information of the electronic device; (viii) check access identifier information of the electronic device; and (ix) accept the download if no error is detected and reject the download if any error is detected.

The processor is further configured to reboot the electronic device after acceptance of the download if no error is detected.

An aspect of the present disclosure provides a system with enhanced detection of potential bricking of an electronic device. The system includes a management server including, a network interface, a processor, and a non-transitory memory configured to store one or more programs; an electronic device including a processor, a non-transitory memory configured to store one or more programs, and a network interface; a log server including a processor, a non-transitory memory configured to store one or more programs, and a network interface; and a network connection configure to establish a communication connection between respective network interfaces of the management server, the electronic device, and the log server.

During a software or firmware download, it is possible for some data to be missing after the data is saved from a buffer to flash memory. In an aspect of the present disclosure, data integrity is checked after the data is saved to flash memory. Accordingly, it is possible to maximize validity of manifest files which are important for secure boot processes, and detect or prevent potential causes of bricking.

Aspects of the present disclosure considerably reduce the possibility of bricking the electronic device, thereby saving replacement costs and reducing the amount of debugging to be performed by developers.

The processor in the electronic device executes a program including download logic for the electronic device to perform checks after an image (e.g., a root file system (RootFS) image) is downloaded and saved to flash memory but before the electronic device is rebooted. For example, when a vendor releases the latest operating system (OS) version for an electronic device, a user may initiate a firmware upgrade so as to upgrade the firmware to the newer version. If no error is detected, the download is accepted. If any error is detected, the download is rejected. In particular, the following is performed after saving to flash memory: (i) CRC checks for each module such as ATOM kernels, ATOM RootFS, ARM kernels and ARM RootFS; (ii) manifest file checks (e.g., run chk_manifest) to verify that manifest files are valid (this can include, for example, a remote procedure call (RPC) from the ARM side); (iii) a basic NVRAM command to read data from NVRAM (such as Media Access Control (MAC) addresses or certificates and Data Over Cable Service Interface Specification (DOCSIS) calibration data) to ensure that the download process did not corrupt the NVRAM (for example, NVRAM_Get API or TrustStore_Get API can be run to verify the MAC addresses or certificates); (iv) if any of the preceding measures fail, the electronic device is prevented from toggling the access identifier (AID) table; (v) if all of the preceding measures are successful, the AID table is toggled; (vi) after toggling, it is determined if there is one active AID; (vii) if any error is detected, then the download is rejected; and (viii) if no error is detected and the download is accepted, the electronic device is then rebooted.

If an error is detected, a log can then be printed and an SSH request can be sent to the electronic device to diagnose the failure. In an aspect of the present disclosure, the download triggers the execution of applets or scripts for collecting information related to the electronic device, and the information collected by execution of the download includes data packets and logs related to operations of the electronic device to be stored on an external server. In an aspect of the present disclosure, the electronic device can be a cable modem and the external server can be a log server.

An aspect of the present disclosure provides a non-transitory computer-readable recording medium for enhanced detection of potential bricking of the electronic device. The non-transitory computer-readable recording medium stores one or more programs which when executed by a processor performs the steps of the methods described above.

### BRIEF DESCRIPTION OF THE DRAWINGS

In the drawings, like reference numbers generally indicate identical, functionally similar, and/or structurally similar elements.

FIG. 1 is a schematic diagram of a system with enhanced detection of potential bricking of an electronic device according to an embodiment of the present disclosure;

FIG. 2 is a more detailed schematic diagram management server/PC, modem/gateway device, and log server in the system of FIG. 1 according to an embodiment of the present disclosure; and

FIG. 3 illustrates a method and algorithm for performing enhanced detection of potential bricking of an electronic device according to an embodiment of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded as merely examples. Accordingly, those of ordinary skill in the art will recognize that various changes and modifications of the examples described herein can be made without departing from the spirit and scope of the present disclosure. In addition, descriptions of well-known functions and constructions may be omitted for clarity and conciseness.

The terms and words used in the following description and claims are merely used to enable a clear and consistent understanding of the present disclosure. Accordingly, it should be apparent to those skilled in the art that the following description of the present disclosure is provided for illustration purposes only, and not for the purpose of limiting the present disclosure as defined by the appended claims and their equivalents.

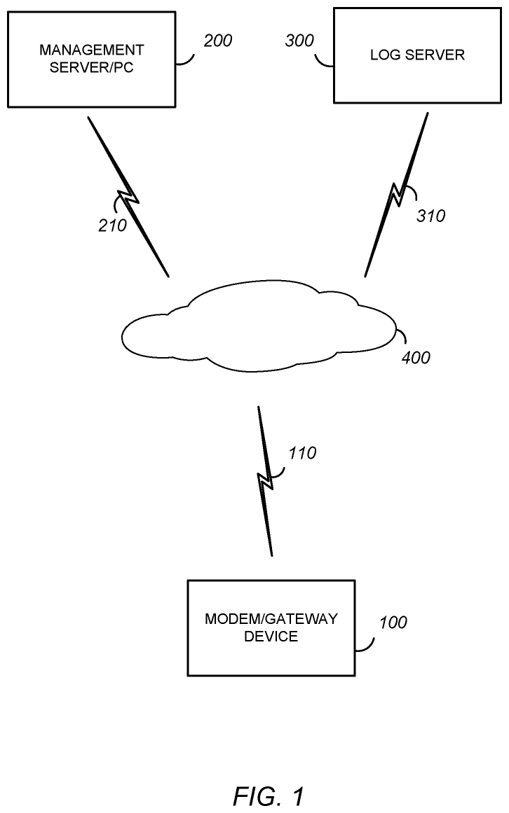

FIG. 1 is a schematic diagram of a system with enhanced detection of potential bricking of an electronic device according to an embodiment of the present disclosure. As shown in FIG. 1, the system includes a management server or personal computer (PC) 200 and a log server 300 connected to a modem/gateway device 100 via the Internet 400.

Starting from the top-left of FIG. 1, the management server/PC 200 may be any type of server or network computer implemented as a management device for communicating, monitoring, and managing other devices (e.g., routers, modems, switches, servers, gateways and other similar devices) connected in a network using a management protocol. For example, the management server/PC 200 can be a Secure Shell protocol (SSH) management device implementing the use of an SSH protocol. The SSH protocol is an Internet standard protocol for collecting, organizing, and modifying information for the managed devices in the network. The devices managed by the management server/PC 200 would also support the use of the same or similar protocol such as the SSH protocol.

By using a management protocol such as the SSH protocol, the management server/PC 200 can send queries, receive responses, set variables, and monitor and acknowledge events with respect to the managed devices. The management server/PC 200 can implement the use of management software or agent (e.g., NET-SSH or MG-SOFT) for performing communicating, monitoring, and management functions related to the managed devices.

The connection 210 between the management server/PC 200 and the Internet 400 can be implemented using a wide area network (WAN), a virtual private network (VPN), metropolitan area networks (MANs), system area networks (SANs), a DOCSIS network, a fiber optics network (such as FTTH (fiber to the home) or FTTX (fiber to the x)), a public switched data network (PSDN), a global Telex network, or a 2G, 3G, 4G or 5G network, for example.

The log server 300 may be any type of server or computer implemented as a network server or network computer for providing various shared resources to other devices connected to the network via the Internet 400. For example, in this case, the log server 300 can be implemented to store configuration data, data packets, logs, log files, or other data files related to the operation and activities performed by modem/gateway device 100 and/or other managed devices in the network. The configuration data, data packets, logs, log files, or other data files can be accessed by, for example, technical support persons, or other administrative or management persons and/or devices. An analysis of the information stored in the log server 300 can be used to examine the operation and activities of the modem/gateway device 100 and other network devices connected in the network.

The connection 310 between the log server 300 and the Internet 400 can be implemented using a WAN, a VPN, MANs, SANs, a DOCSIS network, a fiber optics network (such as FTTH or FTTX), a PSDN, a global Telex network, or a 2G, 3G, 4G or 5G network, for example. The connection 110 between the Internet 400 and the modem/gateway device 100 can be implemented using a digital subscriber line (DSL) connection, a cable modem connection, a broadband mobile phone network, an optical network, or other similar connections. The connection 110 can also be implemented using a wireless connection that operates in accordance with, but is not limited to, IEEE 802.11 protocol, a Radio Frequency For Consumer Electronics (RF4CE) protocol, ZigBee protocol, Z-Wave protocol, or IEEE 802.15.4 protocol. It is also contemplated by the present disclosure that connection 110 is capable of providing connections between the modem/gateway device 100 and a WAN, a LAN, a VPN, MANs, PANs, WLANs, SANs, a PTSA, a global Telex network, or a 2G, 3G, 4G or 5G network.

The modem/gateway device 100 can be a hardware electronic device that functions as a modem, a combined modem and router, or a combined modem, router, and gateway device for providing content received from, for example, a content provider to other network devices (e.g., client devices and/or mobile devices) in one of more wireless networks (not shown). It is also contemplated by the present disclosure that the modem/gateway device 100 can include the function of, but is not limited to, an Internet Protocol/Quadrature Amplitude Modulator (IP/QAM) set-top-box (STB) or smart media device (SMD) that is capable of decoding audio/video (A/V) content, and playing over-the-top (OTT) or multiple system operator (MSO) provided content.

The modem/gateway device 100 may be connected to different wireless networks such as a guest network, a backhaul network, a private network, an iControl network and/or an Internet of Things (IoT) network, which may include one or more client devices and/or mobile devices for receiving content from the content provider connected to the modem/gateway device 100 via, for example, the Internet 400.

It is contemplated by the present disclosure that the modem/gateway device 100 can communicate with one or more client devices and/or mobile devices connected in the different wireless networks using a wireless connection that operates in accordance with Bluetooth protocols (e.g., Bluetooth versions 1.0-3.0 and Bluetooth Low Energy (BLE) versions 4.0-5.0) or other short range protocols that operate in accordance with a wireless technology standard for exchanging data over short distances using short-wavelength UHF radio waves from 2.4 to 2.485 GHz.

Additionally, the modem/gateway device 100 can communicate with one or more client devices and/or mobile devices connected in the different wireless networks using a wireless connection that operates in accordance with, but is not limited to, IEEE 802.11 protocol, RF4CE protocol, ZigBee protocol, Z-Wave protocol, or IEEE 802.15.4 protocol. The one or more client devices and/or mobile devices can include, for example, a computer, a portable device, an electronic tablet, a smart phone, a smart speaker, an IoT device, an iControl device, or another wireless hand-held consumer electronic device capable of executing and displaying the content received through the modem/gateway device 100. It is also contemplated by the present disclosure that modem/gateway device 100 could include connections to a media over coax (MoCA) network.

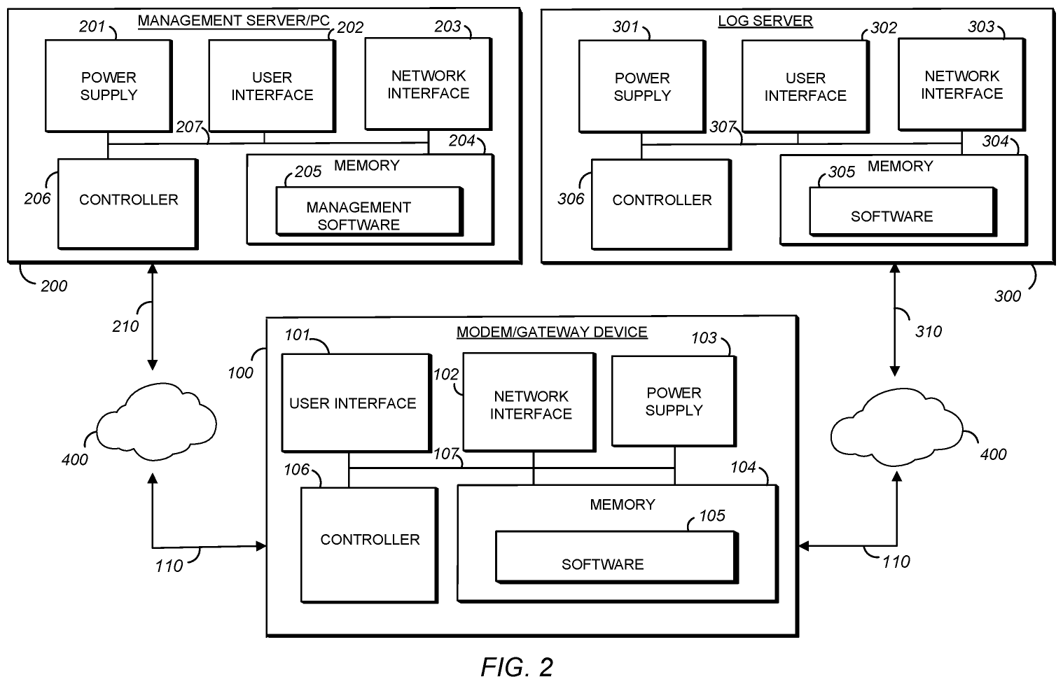

A detailed description of the exemplary internal components of the management server/PC 200, log server 300, and modem/gateway device 100 shown in FIG. 1 will be provided in the discussion of FIG. 2. However, in general, it is contemplated by the present disclosure that the management server/PC 200, log server 300, and modem/gateway device 100 include electronic components or electronic computing devices operable to receive, transmit, process, store, and/or manage data and information associated with the system, which encompasses any suitable processing device adapted to perform computing tasks consistent with the execution of computer-readable instructions stored in a memory or a computer-readable recording medium.

Further, any, all, or some of the computing devices in the management server/PC 200, log server 300, and modem/gateway device 100 may be adapted to execute any operating system, including Linux, UNIX, Windows, MacOS, DOS, and ChromOS as well as virtual machines adapted to virtualize execution of a particular operating system, including customized and proprietary operating systems. The management server/PC 200, log server 300, and modem/gateway device 100 are further equipped with components to facilitate communication with other computing devices over the one or more network connections to local and wide area networks, wireless and wired networks, public and private networks, and any other communication network enabling communication in the system.

FIG. 2 is a more detailed schematic diagram of the management server/PC 200, the log server 300, and the modem/gateway device 100 shown in FIG. 1 according to an embodiment of the present disclosure. Although, FIGS. 1 and 2 only show one management server/PC 200, one log server 300, and one modem/gateway device 100, it is contemplated by the present disclosure that more than one management server/PC 200, log server 300, and modem/gateway device 100 can be implemented. The management server/PC 200, log server 300, and modem/gateway device 100 shown in FIGS. 1 and 2 are meant to be representative of the network devices that can be implemented to achieve the features of the different aspects and embodiments of the present disclosure.

Now referring to FIG. 2 (e.g., from left to right), the management server/PC 400 may be any type of server or network computer implemented as a management device for communicating, monitoring, and managing other devices (e.g., routers, modems, switches, servers, gateways and other similar devices) connected in a network using a management protocol.

As shown in FIG. 2, the management server/PC 200 includes a power supply 201, a user interface 202, a network interface 203, a memory 204, and a controller 206. The power supply 201 supplies power to the internal components of the management server/PC 200 through an internal bus 207. The power supply 201 can include a self-contained power source such as a battery pack with an interface to be powered through an electrical charger connected to an outlet (e.g., either directly or by way of another device). The power supply 201 can also include a rechargeable battery that can be detached allowing for replacement such as a nickel-cadmium (NiCd), nickel metal hydride (NiMH), a lithium-ion (Li-ion), or a lithium Polymer (Li-pol) battery.

The user interface 202 can include, but is not limited to, push buttons, a keyboard, a keypad, a liquid crystal display (LCD), cathode ray tube (CRT), thin film transistor (TFT), light-emitting diode (LED), high definition (HD) or other similar display device including a display device having touch screen capabilities so as to allow interaction between a user and the management server/PC 200. The network interface 203 can include, but is not limited to, various network cards, interfaces, and circuitry implemented in software and/or hardware to enable communications between the management server/PC 200 and the Internet 400 using connection 210. The various network cards, interfaces, and circuitry enable communications via connection 210 using a WAN, a VPN, MANs, SANs, a PTSA, a global Telex network, or a 2G, 3G, 4G or 5G network.

The memory 204 can include a single memory or one or more memories or memory locations that include, but are not limited to, a random access memory (RAM), an NVRAM, a dynamic random access memory (DRAM) a memory buffer, a hard drive, a database, an erasable programmable read only memory (EPROM), an electrically erasable programmable read only memory (EEPROM), a read only memory (ROM), a flash memory, logic blocks of a field programmable gate array (FPGA), hard disk or any other various layers of memory hierarchy.

The memory 204 can be used to store any type of instructions including software such management software 205 or agent associated with algorithms, processes, or operations for controlling the general management and monitoring functions of the management server/PC 200 and associated with enhanced detection of potential bricking of the modem/gateway device 100. For example, management software 205 may include algorithms, processes, or operations for implementing an SSH protocol, which is an Internet standard protocol for collecting, organizing, and modifying information for the managed devices in the network. For example, management software 205 may include NET-SSH or MG-SOFT for performing communicating, monitoring, and management functions related to the modem/gateway device 100.

The devices managed by the management server/PC 200 can include the modem/gateway device 100, which would also support the use of the same or similar protocol such as the SSH protocol. The SSH protocol permits active management tasks, such as monitoring, management, and configuration changes, through the setting and modification of device or network variables. The device or network variables accessible via SSH are organized in hierarchies described as a management information base (MIB). The MIB is a pre-defined structure that stores information such as the device or network variables that can be queried and/or set. The software 205 or agent is responsible for gathering information about network devices such as the modem/gateway device 100 and storing them in a format that can be queried and updated in the MIB.

The controller 206 controls the general operations of the management server/PC 200 and includes, but is not limited to, a central processing unit (CPU), a hardware microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and performing the functions of the management server/PC 200. General communication between the components (e.g., 201-206) of the management server/PC 200 is performed using the internal bus 207.

The log server 300 may be any type of server or computer implemented as a network server or network computer for providing various shared resources to other devices connected to the network via the Internet 400. As shown in FIG. 2, the log server 300 includes a power supply 301, a user interface 302, a network interface 303, a memory 304, and a controller 306.

The power supply 301 supplies power to the internal components of the log server 300 through an internal bus 307. The power supply 301 can include a self-contained power source such as a battery pack with an interface to be powered through an electrical charger connected to an outlet (e.g., either directly or by way of another device). The power supply 301 can also include a rechargeable battery that can be detached allowing for replacement such as a NiCd, a NiMH, a Li-ion, or a Li-pol battery.

The user interface 302 can include, but is not limited to, push buttons, a keyboard, a keypad, an LCD, a CRT, a TFT, an LED, an HD or other similar display device including a display device having touch screen capabilities so as to allow interaction between a user and the log server 300. The network interface 303 can include various network cards, and circuitry implemented in software and/or hardware to enable communications between the log server and the Internet 400 using connection 310.

The various network cards, interfaces, and circuitry of the network interface 303 enable communications via connection 310. The various network cards, interfaces, and circuitry enable communications via connection 310 using a WAN, a VPN, MANs, SANs, a PTSA, a global Telex network, or a 2G, 3G, 4G or 5G network.

The memory 304 can include a single memory or one or more memories or memory locations that include, but are not limited to, a RAM, an NVRAM, a DRAM, a memory buffer, a hard drive, a database, an EPROM, an EEPROM, a ROM, a flash memory, logic blocks of a FPGA, hard disk or any other various layers of memory hierarchy. The memory 304 can be implemented to store data, data packets, logs, log files, or other files related to the operation and activities performed by modem/gateway device 100 and/or other managed devices in the network. The configuration data, data packets, logs, log files, or other files can accessed by, for example, technical support persons, a webmaster, or other administrative or management persons and/or devices. An analysis of the information stored in the log server 300 can be used to examine the operation and activities of the modem/gateway device 100 and other network devices connected in the network.

Additionally, the memory 304 can be used to store any type of instructions associated with algorithms, processes, or operations for controlling the general functions and operations of the log server 300 in accordance with the different aspects and embodiments described in the present disclosure. The controller 306 controls the general operations of the log server 300 and can include, but is not limited to, a CPU, a hardware microprocessor, a multi-core processor, a single core processor, a FPGA, a microcontroller, an ASIC, a DSP, or other similar processing device capable of executing any type of instructions, algorithms, or software for controlling the operation and performing the functions of the modem/gateway device 100. Communication between the components (e.g., 301-306) of the log server 300 is established using the internal bus 307.

The modem/gateway device 100 can be a hardware electronic device that functions as a modem, a combined modem and router, or a combined modem, router, and gateway device for providing content received from, for example, a content provider to other network devices (e.g., client devices and/or mobile device) in one of more wireless networks (not shown).

It is also contemplated by the present disclosure that the modem/gateway device 100 can include the function of, but is not limited to, an Internet Protocol/Quadrature Amplitude Modulator (IP/QAM)-enabled STB or SMD that is capable of decoding audio/video content, and playing OTT or MSO provided content.

As shown in FIG. 2, modem/gateway device 100 includes a user interface 101, a network interface 102, a power supply 103, a memory 104, and a controller 106. The user interface 102 can include, but is not limited to, push buttons, a keyboard, a keypad, an LCD, a CRT, a TFT, an LED, an HD or other similar display device including a display device having touch screen capabilities so as to allow interaction between a user and the modem/gateway device 100. The network interface 102 can include various network cards, and circuitry implemented in software and/or hardware to enable communications between the modem/gateway device 100 and the Internet 400 using connection 110.

The various network cards, interfaces, and circuitry of the network interface 102 enable communications via connection 110 using a digital subscriber line (DSL) connection, a cable modem connection, a broadband mobile phone network, an optical network, or other similar connections. The various network cards, interfaces, and circuitry of the network interface 102 enable communications via connection 110 using a wireless connection that operates in accordance with, but is not limited to, IEEE 802.11 protocol, a Radio Frequency For Consumer Electronics (RF4CE) protocol, ZigBee protocol, Z-Wave protocol, or IEEE 802.15.4 protocol. It is also contemplated by the present disclosure that the various network cards, interfaces, and circuitry of the network interface 102 enable communications via connection 110 using a WAN, a LAN, a VPN, MANs, PANs, WLANs, SANs, a PTSA, a global Telex network, or a 2G, 3G, 4G or 5G network.

It is also contemplated by the present disclosure that the various network cards, interfaces, and circuitry of the network interface 102 enable communications with one or more client devices and/or mobile device connected in different wireless networks using a wireless connection that operates in accordance with, but is not limited to, Bluetooth protocols (e.g., Bluetooth versions 1.0-3.0 and Bluetooth Low Energy (BLE) versions 4.0-5.0) or other short range protocols that operate in accordance with a wireless technology standard for exchanging data over short distances using short-wavelength UHF radio waves from 2.4 to 2.485 GHz.

Additionally, the various network cards, interfaces, and circuitry of the network interface 102 enable communications to one or more client devices and/or mobile device connected in different wireless networks using a wireless connection that operates in accordance with, but is not limited to, IEEE 802.11 protocol, RF4CE protocol, ZigBee protocol, Z-Wave protocol, or IEEE 802.15.4 protocol. The one or more client devices and/or mobile devices can include, but are not limited to, a computer, a portable device, an electronic tablet, a smart phone, a smart speaker, an IoT device, an iControl device, or another wireless hand-held consumer electronic device capable to executing and displaying the content received through the modem/gateway device 100.

The power supply 103 supplies power to the internal components of the modem/gateway device 100 through an internal bus 107. The power supply 103 can include a self-contained power source such as a battery pack with an interface to be powered through an electrical charger connected to an outlet (e.g., either directly or by way of another device). The power supply 103 can also include a rechargeable battery that can be detached allowing for replacement such as a NiCd, a NiMH, a Li-ion, or a Li-pol battery.

The memory 104 includes a single memory or one or more memories or memory locations that can include, but are not limited to, a RAM, an NVRAM, a DRAM, a memory buffer, a hard drive, a database, an EPROM, an EEPROM, a ROM, a flash memory, logic blocks of a FPGA, hard disk or any other various layers of memory hierarchy. The memory 104 can be used to store any type of instructions including software 105 associated with algorithms, processes, or operations for performing enhanced detection of potential bricking of the modem/gateway device 100 in accordance with the aspect and embodiments of the present disclosure.

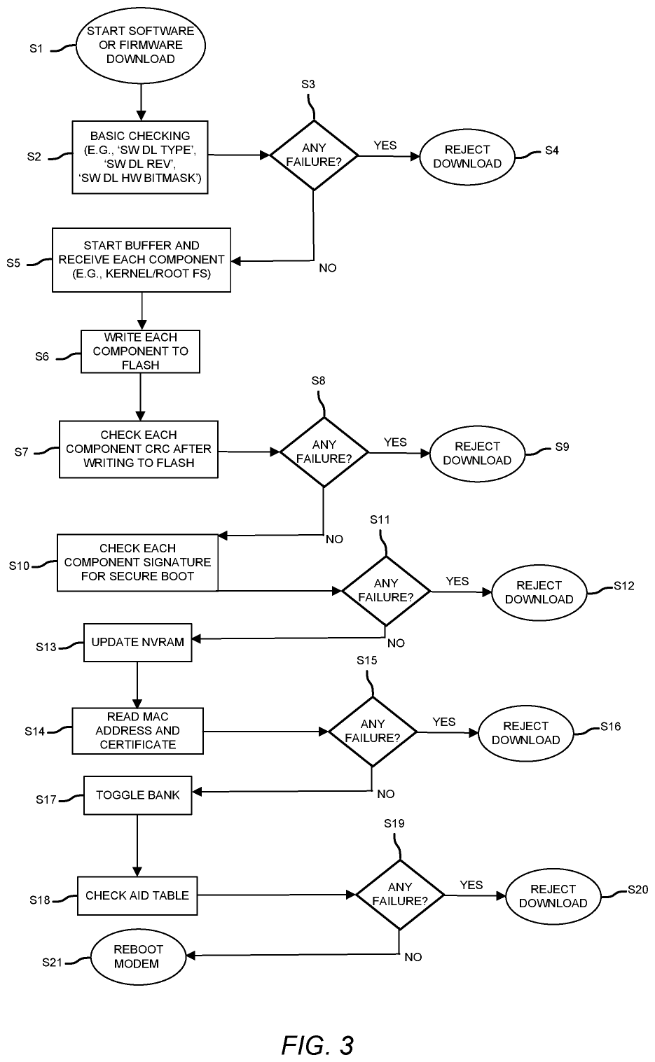

For example, the memory 104 can be implemented to store an official release operating configuration and/or a download configuration associated with the modem/gateway device 100. The download configuration is generally used only for performing download operations and data collection functions (e.g., data, data packets, logs, log files, or other files) associated with the modem/gateway 100 device. On the other hand, the official release operating configuration would be implemented for the operation of the modem/gateway device 100 under normal operating conditions. The use of the download configuration is implemented as part of the enhanced detection of potential bricking of the modem/gateway device 100, which is described in detail with reference to FIG. 3.

The software 105 can support the management protocol implemented by the management server/PC 200 such as the SSH protocol, which allows the management server/PC 200 to send queries, receive responses, set variables, and monitor and acknowledge events associated with the monitoring and management of the modem/gateway device 100 and in association with the enhanced detection of potential bricking of the modem/gateway device 100. Additionally, the software 105 also includes algorithms, processes, or operations for controlling the general functions and operations of the modem/gateway device 100 for performing the functions of the different aspects and embodiments of the present disclosure.

The controller 106 controls the general operations of the modem/gateway device 100 and can include, but is not limited to, a CPU, a hardware microprocessor, a multi-core processor, a single core processor, a FPGA, a microcontroller, an ASIC, a DSP, or other similar processing device capable of executing any type of instructions, algorithms, or software for controlling the operation and performing the functions of the modem/gateway device 100. Communication between the components (e.g., 101-103, and 104-106) of the modem/gateway device 100 is established using the internal bus 107.

FIG. 3 illustrates a method and algorithm for performing enhanced detection of potential bricking of an electronic device according to an embodiment of the present disclosure.

It is assumed that the management server/PC 200, the log server 300, and the modem/gateway device 100 include their respective software 205, 305, 105 stored in their respective memories 204, 304, 104. In FIG. 3, the method and algorithm illustrate operations performed by the software 105 of the modem/gateway device 100 when executed by the controller 106 and performing enhanced detection of potential bricking of the modem/gateway device 100.

Potential causes of bricking include a bad ARM or ATOM secure boot signature, a corrupted ARM or ATOM kernel, a corrupted RootFS image, corrupted NVRAM that wipes out Trusted Store data (e.g., Media Access Control (MAC) addresses and certificates), corrupted NVRAM that wipes out DOCSIS calibration data and prevents the modem/gateway device from coming online, a Unified Extensible Firmware Interface (UEFI) that does not load whatsoever (even if lights on the modem/gateway device stay on), and hardware failure (e.g., an unresponsive switch which software treats as a fatal error and reboots).

The present disclosure provides for enhanced detection of bad ARM or ATOM secure boot signatures, corrupted ARM or ATOM kernels, corrupted RootFS images, and corrupted NVRAM.

In Step S1 of the example method and algorithm of FIG. 3, a user initiates or starts a download (such an upgrade or a downgrade) and a ‘Header’ is first downloaded.

In Step S2, data components defining download parameters of the electronic device are checked. The data components may include kernel information and/or RootFS information. The download parameters may include at least one of software download type (SW DL Type), software download hardware bitmask (SW DL HW Bitmask) and software download revision (SW DL Rev). After the header is downloaded, it is checked if the header contains a certificate (e.g., a PKCS#7 certificate) and if it is legal. For example, product type, hardware type and the certificate are checked. The product type and the hardware type can be checked to ensure that the user does not download an incorrect image to the modem/gateway device 100. The certificate can be checked to ensure that the image is signed by the device manufacturer or content provider. In other words, the certificate will be read from the image's header and the contents of the certificate will be verified as being correct. The root certificate's public key can also be verified to determine if the certificate's signature is correct.

In Step S3, if the certificate is incorrect, the download is then rejected at Step S4. If the certificate is correct, the remainder of the image then downloaded.

In Step S5, a buffer is started and each of the data components is received. For example, ARM kernel, ARM RootFS, ATOM kernel and/or ATOM RootFS information is read from the image.

In Step S6, each of the data components is written into the flash memory. For example, the ARM kernel, ARM RootFS, ATOM kernel and/or ATOM RootFS information is saved to flash memory.

In Step S7, a CRC of each of the data components is performed. For example, each data component (ARM kernel/RootFS and/or ATOM kernel/RootFS) is saved to a specific partition. The data is then read back from each partition and the CRC is calculated. The calculated CRC is then compared with the CRC within the image.

In Step S8, if any calculated CRC does not match, the download is then rejected at Step S9. If all of the calculated CRCs match, the method proceeds to Step S10.

In Step S10, a signature of each of the data components is checked. For example, a secure boot manifest file is run to verify each data component's content and that its signature is correct.

In Step S11, if any signature is incorrect, the download is then rejected at Step S12. If all of the signatures are correct, the method proceeds to Step S13.

In Step S13, download settings in the NVRAM are updated. For example, ‘CVC start time’, swadminstatus, swoperstatus and last download filename are saved to NVRAM.

In Step S14, client identifier information is checked. For example, the NVRAM is commanded (e.g., NVRAM Read API) to read back MAC addresses or certificates.

In Step S15, if any MAC or certificate is incorrect, the download is then rejected at Step S16. If all of the MACs and certificates are correct, the method proceeds to Step S17.

In Step S17, the AID table is updated (i.e., toggle bank). The AID table is a data structure which will contain information like Bank Index, Bank Active (0/1) and other information. If for example, both Bank 0 and Bank 1 are marked as ‘Inactive’, this will brick the modem/gateway device 100 because the bootloader will not find any active bank. For example, after the download but before rebooting the modem/gateway device 100, the current active bank is 0. Then, it is advantageous to update the AID table of Bank 0's ‘active state’ to ‘Inactive’ and the AID table of Bank 1's ‘active state’ to ‘Active’. If there is any error and it is not possible to boot up from one bank, it is possible to switch to another bank and boot up therefrom. Accordingly, the download image can be stored in an ‘Inactive’ bank.

In Step S18, access identifier information is checked. For example, it is verified whether the AID table is correct. Accordingly, this indicates to the bootloader which bank it should boot from.

In Step S19, if the AID table is incorrect, the download is then rejected at Step S20. If the AID table is correct, the download is accepted and the method proceeds to Step S21. That is, the controller 106 will execute the software 105 stored in the memory 104 of the modem/gateway device 100 to complete the download.

In Step S21, the modem/gateway device 100 is rebooted. It is contemplated by the present disclosure that the acceptance of the download and the rebooting of the modem/gateway device 100 can be performed either simultaneously or sequentially, but the acceptance of the download and the rebooting of the modem/gateway device 100 will generally be performed sequentially. However, Step S19 and Step S21 may be combined such that, after checking access identifier information (e.g., the AID table) of the modem/gateway device 100: (i) the modem/gateway device 100 is rebooted if no error is detected (i.e., the acceptance of the download and the rebooting of the modem/gateway device 100 are performed simultaneously); and (ii) the download is rejected if any error is detected.

If the download is accepted, the software/firmware upgrade or downgrade is retained in memory and is implemented. If the download is rejected, the software/firmware upgrade or downgrade is not implemented. For example, the rejected download can be immediately erased from the memory 104, the rejected download can be stored in the memory 104 to be overwritten by future downloads, or the rejected download can be stored in the memory 104 such that a log can be printed and an SSH request can be sent to the modem/gateway device 100 to diagnose the failure. The rejected download can be stored in segments or as a complete file. For instance, the rejected download can be an artifact download containing erroneous data that could be helpful for troubleshooting systemic malfunctions.

In alternative variations, the above-noted operations may be part of an MIB that is implemented for defining and controlling the execution of a download operation on the modem/gateway device 100. For example, management software 205 of the management server/PC 200 may include algorithms, processes, or operations for implementing an SSH protocol such as through NET-SSH or MG-SOFT, and the SSH protocol is an Internet standard protocol for collecting, organizing, and modifying information for the managed devices in a network.

The management software 205 when executed by the controller 206 can be implemented for performing communicating, monitoring, and management functions using the SSH protocol through, for example, NET-SSH or MG-SOFT. An aspect of the SSH protocol is active management tasks such as monitoring, management, and configuration changes, through the setting and modification of device or network variables in the MIB, which is a pre-defined structure that stores information such as the device or network variables that can be queried and/or set using the SSH protocol.

It is contemplated by the present disclosure that managed devices (e.g., routers, modems, switches, servers, gateways and other similar devices) by the management server/PC 200 such as the modem/gateway device 100 include software 105, which supports the use of the same or similar protocol implemented by the management server/PC 200, such as the SSH protocol. Communications using the SSH protocol between the management server/PC 200 and the modem/gateway device 100 using their respective network interfaces 203, 102 and network connections 400, 110, 210, enable the modem/gateway device 100 to receive data from the MIB for executing the download operation. For example, the software 205 in the management server/PC 200 can include a NET-SSH tool, which is used to send an SSH request. The software 105 in the modem/gateway device 100 can include an SSH-AGENT tool, which is used to receive the SSH request and respond to it. It is contemplated by the present disclosure that the download operation can be requested or initiated by the modem/gateway device 100 and/or the management server/PC 200.

In some variations, if an error is detected, the download operation on the modem/gateway device 100 will trigger the execution of applets and scripts that can collect current configuration data, data packets, logs, log files, and other data associated with the operation of the modem/gateway device 100. The applets and scripts with continue to execute and collect configuration data, data packets, logs, log files, and other data. The modem/gateway device 100 can package all the configuration data, logs, log files, and other data files collected during execution of the download operation and transmit the packaged data to the log server 300 via the respective network interfaces 102, 302 and the connections 400, 110, 310 between the modem/gateway device 100 and the log server 300. For example, the software 105 in the modem/gateway device 100 can include an SFTP-CLIENT tool, which is used to send the collected data, logs, and other data files to the log server 300. The software 305 in log server 300 can include an SFTP-SERVER tool, which is used to receive the collected data, logs, and other data files from the modem/gateway device 100. The configuration data, data packets, logs, log files, or other files stored in the log server 300 can be accessed by, for example, technical support persons, or other administrative or management persons and/or devices. An analysis of the information stored in the log server 300 can be used to examine the operation and activities of the modem/gateway device 100 and other network devices connected in the network.

By checking data integrity after the data is saved to flash memory and verifying that the AID table is correct, it is possible to provide enhanced detection of potential bricking of the electronic device.

The present disclosure may be implemented as any combination of an apparatus, a system, an integrated circuit, and a computer program on a non-transitory computer readable recording medium. The one more processors may be implemented as an integrated circuit (IC), an application specific integrated circuit (ASIC), or large scale integrated circuit (LSI), system LSI, super LSI, or ultra LSI components that perform a part or all of the functions described in the present disclosure.

The present disclosure includes the use of software, applications, computer programs, or algorithms. The software, applications, computer programs, or algorithms can be stored on a non-transitory computer-readable medium for causing a computer, such as the one or more processors, to execute the steps described in FIG. 3. For example, the one or more memories stores software or algorithms with executable instructions and the one or more processors can execute a set of instructions of the software or algorithms in association with enhanced detection of potential bricking of the electronic device in accordance with the aspects and embodiments of the present disclosure.

The software and computer programs, which can also be referred to as programs, software applications, applications, components, or code, include machine instructions for a programmable processor, and can be implemented in a high-level procedural language, an object-oriented programming language, a functional programming language, a logical programming language, or an assembly language or machine language. The term computer-readable recording medium refers to any computer program product, apparatus or device, such as a magnetic disk, optical disk, solid-state storage device, memory, and programmable logic devices (PLDs), used to provide machine instructions or data to a programmable data processor, including a computer-readable recording medium that receives machine instructions as a computer-readable signal.

By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Use of the phrases “capable of,” “capable to,” “operable to,” or “configured to” in one or more embodiments, refers to some apparatus, logic, hardware, and/or element designed in such a way to enable use of the apparatus, logic, hardware, and/or element in a specified manner. The subject matter of the present disclosure is provided as examples of apparatus, systems, methods, and programs for performing the features described in the present disclosure. However, further features or variations are contemplated in addition to the features described above. It is contemplated that the implementation of the components and functions of the present disclosure can be done with any newly arising technology that may replace any of the above implemented technologies.

Additionally, the above description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, features described with respect to certain embodiments may be combined in other embodiments.

We claim:

1. An electronic device with enhanced detection of potential bricking, the electronic device comprising:
flash memory;
non-volatile random access memory (NVRAM); and
a processor,
wherein, the processor is configured to, after initiation of a download:
(i) check data components defining download parameters of the electronic device;
(ii) start a buffer and receive each of the data components;
(iii) write each of the data components into the flash memory;
(iv) read each of the data components from the flash memory and perform a cyclic redundancy check (CRC) of each of the data components;
(v) check a signature of each of the data components;
(vi) update download settings in the NVRAM based on results of (i), (iv) and (v);
(vii) check client identifier information of the electronic device;
(viii) check access identifier information of the electronic device; and
(ix) accept the download if no error is detected and reject the download if any error is detected.

2. The electronic device of claim 1, wherein the processor is further configured to reboot the electronic device after acceptance of the download if no error is detected.

3. The electronic device of claim 1, wherein the download parameters include at least one of SW DL Type, SW DL HW Bitmask and SW DL Rev.

4. The electronic device of claim 1, wherein the data components include at least one of kernel information and root file system (RootFS) information.

5. The electronic device of claim 1, wherein the processor is further configured to toggle banks of the NVRAM before checking the access identifier information of the electronic device.

6. The electronic device of claim 1, wherein the signature includes secure boot authentication.

7. The electronic device of claim 1, wherein the client identifier information includes at least one of a media access control (MAC) address and a certificate.

8. The electronic device of claim 1, wherein the electronic device is a modem or a router.

9. A method implemented on an electronic device with enhanced detection of potential bricking, the method comprising:
after initiation of a download,
(i) checking data components defining download parameters of the electronic device;
(ii) starting a buffer and receiving each of the data components;
(iii) writing each of the data components into flash memory;
(iv) reading each of the data components from the flash memory and performing a cyclic redundancy check (CRC) of each of the data components;
(v) checking a signature of each of the data components;
(vi) updating download settings in non-volatile random access memory (NVRAM) based on results of (i), (iv) and (v);
(vii) checking client identifier information of the electronic device;
(viii) checking access identifier information of the electronic device; and
(ix) accepting the download if no error is detected and rejecting the download if any error is detected.

10. The method of claim 9, further comprising rebooting the electronic device after acceptance of the download if no error is detected.

11. The method of claim 9, wherein the download parameters include at least one of SW DL Type, SW DL HW Bitmask and SW DL Rev.

12. The method of claim 9, wherein the data components include at least one of kernel information and root file system (RootFS) information.

13. The method of claim 9, further comprising toggling banks of the NVRAM before checking the access identifier information of the electronic device.

14. The method of claim 9, wherein the signature includes secure boot authentication.

15. A non-transitory computer readable storage medium having stored thereon a program implemented on an electronic device with enhanced detection of potential bricking, the program causing the electronic device to perform steps comprising:
after initiation of a download,
(i) checking data components defining download parameters of the electronic device;
(ii) starting a buffer and receiving each of the data components;
(iii) writing each of the data components into flash memory;
(iv) reading each of the data components from the flash memory and performing a cyclic redundancy check (CRC) of each of the data components;
(v) checking a signature of each of the data components;
(vi) updating download settings in non-volatile random access memory (NVRAM) based on results of (i), (iv) and (v);
(vii) checking client identifier information of the electronic device;
(viii) checking access identifier information of the electronic device; and
(ix) accepting the download if no error is detected and rejecting the download if any error is detected.

16. The non-transitory computer readable storage medium of claim 15, wherein the program causes the electronic device to perform a further step of rebooting the electronic device after acceptance of the download if no error is detected.

17. The non-transitory computer readable storage medium of claim 15, wherein the download parameters include at least one of SW DL Type, SW DL HW Bitmask and SW DL Rev.

18. The non-transitory computer readable storage medium of claim 15, wherein the data components include at least one of kernel information and root file system (RootFS) information.

19. The non-transitory computer readable storage medium of claim 15, wherein the program causes the electronic device to perform a further step of toggling banks of the NVRAM before checking the access identifier information of the electronic device.

20. The non-transitory computer readable storage medium of claim 15, wherein the signature includes secure boot authentication.
